(19) United States
(12) Patent Application Publication
(10) Pub. No.: US 2024/0014479 A1
(43) Pub. Date: Jan. 11, 2024

(54) SEALED BATTERY AND METHOD FOR MANUFACTURING THE SAME

(71) Applicant: Prime Planet Energy & Solutions, Inc., Tokyo (JP)

(72) Inventor: Takafumi TSUJIGUCHI, Himeji-shi (JP)

(21) Appl. No.: 18/347,561

(22) Filed: Jul. 6, 2023

(30) Foreign Application Priority Data
Jul. 11, 2022 (JP) 2022-111152

(51) Int. Cl. H01M 50/169; H01M 50/188; H01M 50/15; H01M 50/103

(52) U.S. Cl. CPC H01M 50/169; H01M 50/188; H01M 50/15; H01M 50/103

(57) ABSTRACT

A sealed battery includes: a battery case including an opening and housing an electrode body; a closing plate closing the opening; a fitted portion between the battery case and the closing plate; a collector terminal including an external connector exposed at an outer surface of the closing plate; and a resin insulator insulating the closing plate from the external connector. At least in an area where the fitted portion and the insulator are located closest to each other, a groove is provided in the fitted portion, and the fitted portion including the groove is subjected to laser welding.

### CROSS REFERENCE TO RELATED APPLICATION

This application claims the benefit of priority to Japanese Patent Application No. 2022-111152 filed on Jul. 11, 2022. The entire contents of this application are hereby incorporated herein by reference.

### BACKGROUND OF THE DISCLOSURE

### 1. Field

The present application relates to sealed batteries and methods for manufacturing the sealed batteries.

### 2. Background

A sealed battery known in the art includes: an electrode body including an electrode; a battery case including an opening and housing the electrode body; a closing plate including a terminal insertion hole and closing the opening; a collector terminal whose first end is connected to the electrode inside the battery case and whose second end is inserted through the terminal insertion hole and extending out of the closing plate; and a resin insulating member insulating an outer surface of the closing plate from the collector terminal. Prior art documents related to such a sealed battery include, for example, JP 2008-251474 A, JP 2021-086813 A, JP 2005-116208 A, JP 2016-087616 A, JP 2017-111896 A, and JP 2019-084540 A. JP 2008-251474 A, for example, discloses a technique involving housing an electrode body in a battery case through its opening, fitting a closing plate to the opening, and then performing laser welding on a fitted portion such that the opening is sealed.

### SUMMARY

A recent high-energy-density battery has a short distance between a collector terminal (which is inserted through a terminal insertion hole of a closing plate) and a fitted portion, so that a laser-welded region is located close to an insulator. In performing laser welding in the course of manufacture of such a high-energy-density battery, a change in the position of a workpiece, for example, may cause the incident angle of laser light to deviate to some degree. If reflected laser light is applied to an insulator as a result of the deviation of incident angle, the insulator may absorb the reflected light and may thus be seared. Studies conducted by the inventor of the present application suggest that the seared insulator suffers degradation, which may lead to a reduction in the insulating capacity of the insulator and/or a reduction in the airtightness of a resulting battery. Consequently, what is now desired is to protect an insulator from reflected laser light.

Accordingly, embodiments of the present application provide sealed batteries each including an insulator whose degradation is prevented or reduced during laser welding, and methods for manufacturing the sealed batteries.

An embodiment of the present application provides a sealed battery including: an electrode body including an electrode; a battery case including an opening and housing the electrode body; a closing plate including a terminal insertion hole and closing the opening; a fitted portion between the battery case and the closing plate; a collector terminal including an electrode body connector connected to the electrode inside the battery case, a shaft inserted through the terminal insertion hole, and an external connector exposed at an outer surface of the closing plate; and a resin insulator insulating the outer surface of the closing plate from the external connector. At least in an area where the fitted portion and the insulator are located closest to each other, a groove is provided in the fitted portion, and the fitted portion including the groove is subjected to laser welding.

This embodiment involves applying laser light to the inside of the groove of the fitted portion. Reflected light is thus absorbed by wall surfaces of the groove, making it difficult for the reflected light to leak out of the groove. Thus, if, for example, a region to be subjected to laser welding is located close to the insulator or the incident angle of laser light is somewhat deviated during laser welding, this embodiment would make it unlikely that the reflected laser light will be applied to the insulator. Consequently, this embodiment is able to prevent searing of the insulator and eventually prevent a reduction in the insulating capacity of the insulator and a reduction in the airtightness of the battery.

The above and other elements, features, steps, characteristics, and advantages of the present application will become more apparent from the following detailed description of the preferred embodiments with reference to the attached drawings.

### BRIEF DESCRIPTION OF THE DRAWINGS

FIG. 1 is a schematic perspective view of a sealed battery according to an embodiment of the present application.

FIG. 2 is an exploded perspective view of the sealed battery illustrated in FIG. 1.

FIG. 3 is a cross-sectional view of the sealed battery taken along the line in FIG. 1.

FIG. 4 is a plan view of the sealed battery illustrated in FIG. 1.

FIG. 5 is a vertical cross-sectional view of a portion of the sealed battery adjacent to a groove during a laser welding step.

FIG. 6 is a vertical cross-sectional view of a portion of a sealed battery according to a first variation, which is located adjacent to a groove.

FIG. 7 is a vertical cross-sectional view of a portion of a sealed battery according to a second variation, which is located adjacent to a groove.

FIG. 8 is a plan view of a portion of a sealed battery according to a third variation, which is located adjacent to a groove.

### DETAILED DESCRIPTION OF THE PREFERRED EMBODIMENTS

Preferred embodiments of techniques disclosed herein will be described below with reference to the drawings. Matters that are necessary for carrying out the present application but are not specifically mentioned herein (e.g., common battery structures and manufacturing processes that do not characterize the present application) may be understood by those skilled in the art as design matters based on techniques known in the related art. The techniques disclosed herein may be carried out on the basis of the description given herein and common technical knowledge in the related art. In what follows, components and elements having the same functions are identified by the same reference signs, and description thereof may be simplified or omitted when deemed redundant.

As used herein, the term “battery” refers to any of various electricity storage devices from which electric energy is derivable, and is a concept encompassing primary batteries and secondary batteries. As used herein, the term “secondary battery” refers to any of various electricity storage devices, each of which is repeatedly chargeable and dischargeable by movement of charge carriers between a positive electrode and a negative electrode through an electrolyte. The electrolyte may be any of a liquid electrolyte (i.e., an electrolytic solution), a gel electrolyte, and a solid electrolyte. The term “secondary battery” subsumes not only storage batteries (or chemical batteries), such as lithium ion secondary batteries and nickel-metal hydride batteries, but also capacitors (or physical batteries), such as electric double layer capacitors. The following description focuses on an embodiment intended for a lithium ion secondary battery.

Sealed Battery 100

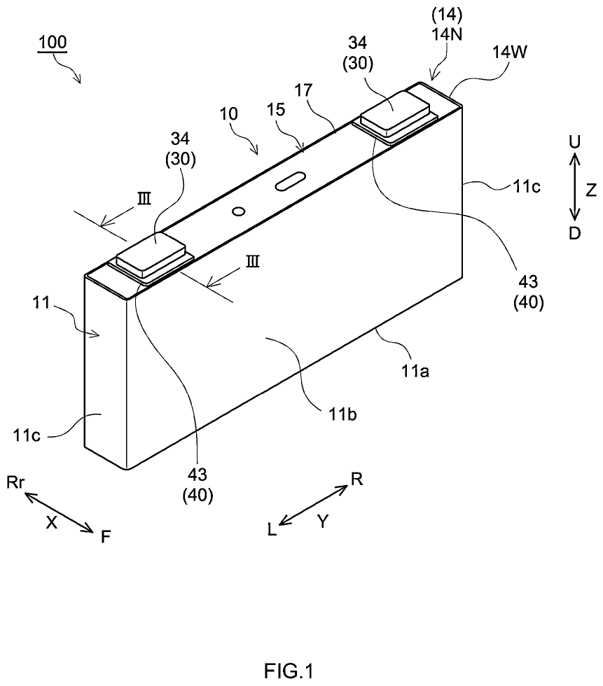

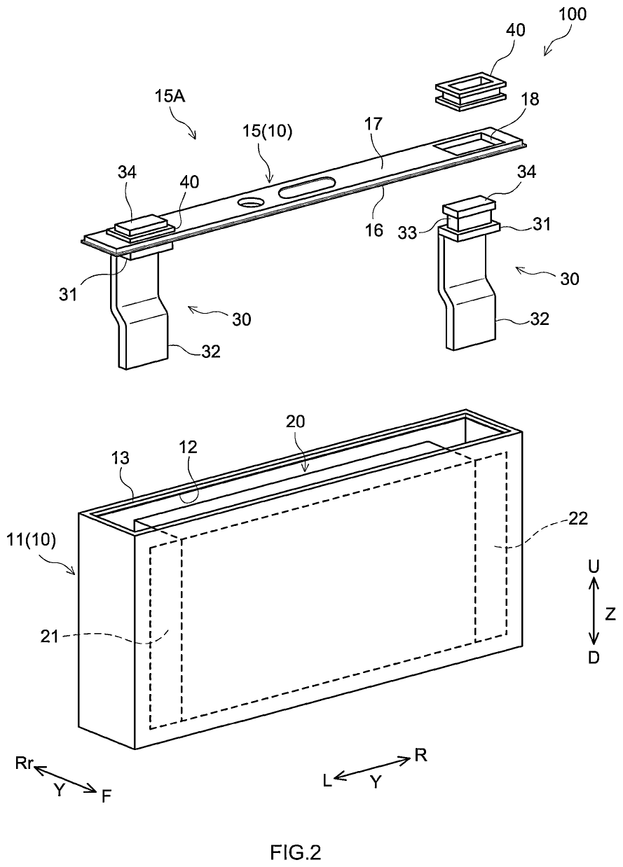

FIG. 1 is a perspective view of a sealed battery 100. FIG. 2 is an exploded perspective view of the sealed battery 100. In the following description, the reference signs L, R, F, Rr, U, and D in the drawings respectively represent left, right, front, rear, up, and down. A direction along the short sides of the sealed battery 100 in a plan view will hereinafter be referred to as a “short-side direction X”. A direction along the long sides of the sealed battery 100 in the plan view will hereinafter be referred to as a “long-side direction Y”. A direction along the height of the sealed battery 100 will hereinafter be referred to as an “up-down direction Z”. These directions, however, are defined merely for the sake of convenience of description and do not limit in any way how the sealed battery 100 may be installed.

As illustrated in FIG. 2, the sealed battery 100 includes an exterior body 10, an electrode body 20, collector terminals 30, and insulators 40. Although not illustrated, the sealed battery 100 in the present embodiment further includes an electrolytic solution. In FIG. 2, an assembly component (hereinafter referred to as a “lid assembly 15A”) provided by insert-molding the collector terminals 30 and the insulators 40 to a closing plate 15 of the exterior body 10 is illustrated as being separated from other components. In FIG. 2, the collector terminal 30 to be connected to an electrode on one side in the long-side direction Y (i.e., the right side in FIG. 2), the associated insulator 40, and the closing plate 15 are illustrated as being separated from each other.

The exterior body 10 includes a battery case 11 and the closing plate (or lid) 15. As illustrated in FIG. 1, the exterior body 10 in the present embodiment has a flat cuboidal outer shape (or rectangular outer shape). The exterior body 10 may be made of a material similar to any material known in the art or may be made of any other suitable material. The exterior body (which includes the battery case 11 and the closing plate 15) is made of, for example, aluminum, an aluminum alloy, stainless steel, iron, or an iron alloy. In the present embodiment, the exterior body 10 is made of aluminum.

As illustrated in FIG. 2, the battery case 11 is a casing housing the electrode body 20 and storing the electrolytic solution. The battery case 11 is a rectangular container with a bottom. The battery case 11 is provided at its upper surface with an opening 12. The opening 12 has a substantially rectangular shape. As illustrated in FIG. 1, the battery case 11 includes: a bottom wall 11a including long sides and short sides; a pair of long side walls 11b extending upward from the long sides of the bottom wall 11a and facing each other; and a pair of short side walls 11c extending upward from the short sides of the bottom wall 11a and facing each other. The bottom wall 11a has a substantially rectangular shape. As used herein, the term “substantially rectangular shape” refers to not only a perfect rectangular shape (or a perfect oblong shape) but also various other rectangular shapes, such as a rectangular shape whose corners connecting long and short sides are rounded and a rectangular shape whose corners have cut-outs.

The battery case 11 may have any suitable thickness. From the viewpoint of durability, for example, the battery case 11 preferably has a thickness of about 0.5 mm or more (e.g., 1 mm or more). From the viewpoint of cost and energy density, the battery case 11 preferably has a thickness of about 3 mm or less (e.g., 2 mm or less).

The closing plate 15 is a plate member fitted to the opening 12 of the battery case 11 so as to close the opening 12. The closing plate 15 has a substantially rectangular shape. The closing plate 15 is smaller in outer shape than the opening 12 of the battery case 11. The closing plate 15 faces the bottom wall 11a of the battery case 11. The closing plate 15 includes: an inner surface 16 facing toward the inside of the sealed battery 100; and an outer surface 17 facing toward the outside of the sealed battery 100. The closing plate 15 includes two terminal insertion holes 18 passing through the closing plate 15 in the up-down direction Z. The terminal insertion holes 18 are each defined in an associated one of the ends of the closing plate 15 in the long-side direction Y. The terminal insertion hole 18 on a first side in the long-side direction Y (i.e., the left side in FIG. 2) is provided for a positive electrode. The terminal insertion hole 18 on a second side in the long-side direction Y (i.e., the right side in FIG. 2) is provided for a negative electrode.

The closing plate 15 may have any suitable thickness. From the viewpoint of durability, for example, the closing plate 15 preferably has a thickness of about 0.3 mm or more (e.g., 0.5 mm or more). From the viewpoint of cost and energy density, the closing plate 15 preferably has a thickness of about 2 mm or less (e.g., 1.5 mm or less). The closing plate 15 may be smaller in thickness than the battery case 11.

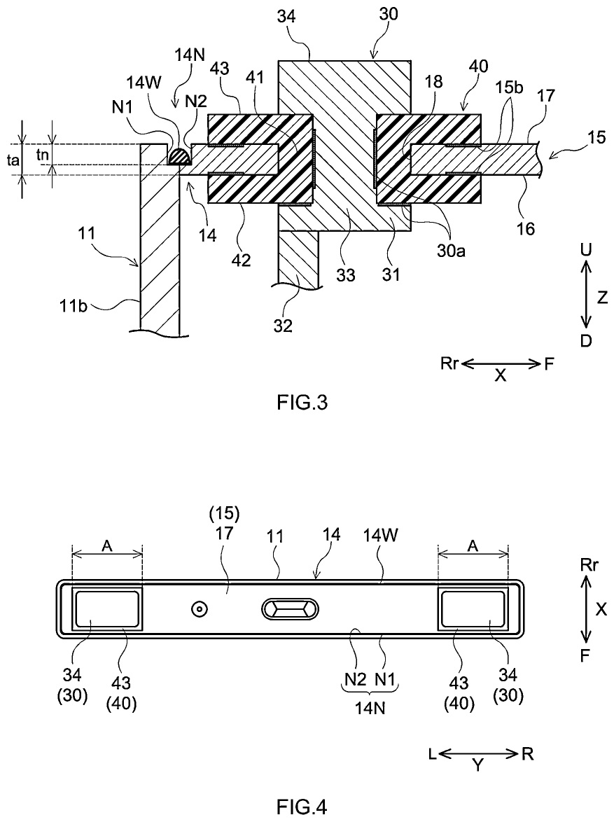

The surfaces of portions of the closing plate 15 in contact with the insulators 40 are at least partially subjected to a roughening process. The roughening process is a surface treatment involving making the surfaces uneven so as to increase surface areas and enhance anchor effect, thus promoting bonding or adhesion of the closing plate 15 to the insulators 40. The roughening process may be performed by, for example, application of laser light or sand blasting. The portions of the closing plate 15 subjected to the roughening process define roughened portions 15b (see FIG. 3). In the present embodiment, the roughened portions 15b are provided in: regions of the inner surface 16 located around the terminal insertion holes 18; and regions of the outer surface 17 located around the terminal insertion holes 18. Alternatively, the roughened portions 15b may be provided, for example, across the entire regions of the closing plate 15 in contact with the insulators 40. The roughened portions 15b may be optional.

The electrode body 20 is housed in the battery case 11. The electrode body 20 covered with, for example, a resin insulating film (not illustrated) is housed in the battery case 11. The electrode body 20 includes a positive electrode sheet 21, a negative electrode sheet 22, and separator sheets (not illustrated) disposed between the positive electrode sheet 21 and the negative electrode sheet 22. Each of the positive electrode sheet 21 and the negative electrode sheet 22 is an example of an electrode. In the present embodiment, the electrode body 20 is a wound electrode body provided by placing strip-shaped positive and negative electrode sheets 21 and 22 on top of another, with two strip-shaped separator sheets interposed therebetween, and winding the positive and negative electrode sheets 21 and 22 and the separator sheets around the longitudinal axis of the electrode body 20. Alternatively, the electrode body 20 may be a laminated electrode body including quadrangular positive and negative electrodes stacked on top of another such that the positive and negative electrodes are insulated from each other.

The positive electrode sheet 21 includes: a positive electrode collector (which is made of, for example, aluminum foil); and a positive electrode active material layer (which contains a positive electrode active material) fixed onto at least one of surfaces of the positive electrode collector. The positive electrode sheet 21 is not limited to any particular structure and may be similar to any positive electrode sheet used in any battery known in the art. The positive electrode active material may be any material known in the art. Examples of the positive electrode active material include a lithium transition metal composite oxide. The negative electrode sheet 22 includes: a negative electrode collector (which is made of, for example, copper foil); and a negative electrode active material layer (which contains a negative electrode active material) fixed onto at least one of surfaces of the negative electrode collector. The negative electrode sheet 22 is not limited to any particular structure and may be similar to any negative electrode sheet used in any battery known in the art. The negative electrode active material may be any material known in the art. Examples of the negative electrode active material include a carbon material, such as graphite. The separator sheets are insulating resin sheets with minute through holes that allow passage of charge carriers therethrough. The separator sheets are not limited to any particular structure and may each be similar to any separator sheet used in any battery known in the art.

The positive electrode sheet 21 is disposed in the battery case 11 such that one end of the positive electrode sheet 21 is located on the first side in the long-side direction Y (i.e., the left side in FIG. 2). The negative electrode sheet 22 is disposed in the battery case 11 such that one end of the negative electrode sheet 22 is located on the second side in the long-side direction Y (i.e., the right side in FIG. 2). Although the collector terminals 30 are illustrated as being separated from the positive electrode sheet 21 and the negative electrode sheet 22 in FIG. 2, the collector terminals 30 are each welded to an associated one of the positive electrode sheet 21 and the negative electrode sheet 22 when the sealed battery 100 is in finished form.

As illustrated in FIGS. 1 and 2, the collector terminals 30 are each disposed on an associated one of the ends of the closing plate 15 in the long-side direction Y. The collector terminal 30 for the positive electrode is made of, for example, aluminum or an aluminum alloy. The collector terminal 30 for the negative electrode is made of, for example, copper or a copper alloy.

FIG. 3 is a cross-sectional view of the sealed battery 100 taken along the line in FIG. 1. In FIG. 3, one of the two long side walls 11b of the battery case 11 is not illustrated. As illustrated in FIGS. 2 and 3, the collector terminals 30 each include a base 31, an electrode body connector 32, a shaft 33, and an external connector 34. As illustrated in FIG. 2, each base 31 in the present embodiment has a quadrangular flat plate shape and extends in a horizontal direction. The size of each base 31 is such that each base 31 is insertable through the associated terminal insertion hole 18. Each electrode body connector 32 is disposed in the battery case 11. In the present embodiment, each electrode body connector 32 has a plate shape and extends downward from the rear end of the associated base 31. An end of each electrode body connector 32 is electrically connected to the positive electrode sheet 21 or the negative electrode sheet 22 of the electrode body 20 inside the battery case 11.

Each shaft 33 is disposed between the associated electrode body connector 32 and the associated external connector 34. Each shaft 33 is inserted through the associated terminal insertion hole 18. Each shaft 33 extends upward from the associated base 31. Each external connector 34 is disposed such that each external connector 34 is exposed at the outer surface 17 of the closing plate 15. Each external connector 34 is disposed over the associated shaft 33. The size of each external connector 34 is such that each external connector 34 is insertable through the associated terminal insertion hole 18. Each shaft 33 is smaller in outer size than the associated base 31 and the associated external connector 34, so that each shaft 33 is constricted relative to the associated base 31 and the associated external connector 34.

The surfaces of portions of each collector terminal 30 in contact with the associated insulator 40 are at least partially subjected to a roughening process similar to that performed on the closing plate 15. The portions of each collector terminal 30 subjected to the roughening process define roughened portions 30a (see FIG. 3). In the present embodiment, the roughened portions 30a are provided on the shafts 33 and the upper surfaces of the bases 31. Alternatively, the roughened portions 30a may be provided, for example, across the entire regions of the collector terminals 30 in contact with the insulators 40. The roughened portions 30a may be optional.

The insulators 40 each prevent conduction between the closing plate 15 and the associated collector terminal 30. The insulators 40 are made of resin. The insulators 40 are each made of, for example, fluorine resin, such as perfluoro alkoxy alkane (PFA) or polytetrafluoroethylene (PTFE), or a synthetic resin material, such as polyphenylene sulfide (PPS). An additive, such as an inorganic filler, may be added to the synthetic resin material. As illustrated in FIG. 3, the insulators 40 each include a tubular portion 41, a first flange 42, and a second flange 43. The tubular portion 41, the first flange 42, and the second flange 43 of each insulator 40 are integral with each other.

Each tubular portion 41 is located between the associated terminal insertion hole 18 and the shaft 33 of the associated collector terminal 30. Each tubular portion 41 insulates the associated terminal insertion hole 18 from the associated shaft 33. Each first flange 42 extends horizontally from the associated tubular portion 41 along the inner surface 16 of the closing plate 15. Each first flange 42 insulates the inner surface 16 of the closing plate 15 from the associated base 31. Each second flange 43 extends horizontally from the associated tubular portion 41 along the outer surface 17 of the closing plate 15. Each second flange 43 insulates the outer surface 17 of the closing plate 15 from the associated external connector 34. The first flange 42 and the second flange 43 of each insulator 40 are larger in outer shape than the base 31 and the external connector 34 of the associated collector terminal 30. As illustrated in FIGS. 1 and 3, each second flange 43 is projected outward of the associated collector terminal 30 in the plan view and exposed externally.

As illustrated in FIG. 2, the lid assembly 15A is an assembly component provided by insert-molding the collector terminals 30 and the insulators 40 to the closing plate 15 such that the closing plate 15, the collector terminals 30, and the insulators 40 are integral with each other. The closing plate 15 and the collector terminals 30 are firmly secured to the insulators 40 through the roughened portions 15b of the closing plate 15 and the roughened portions 30a of the collector terminals 30. The collector terminals 30 are thus secured to the closing plate 15 without swaging the bases 31 or bringing the collector terminals 30 into direct contact with the closing plate 15. The terminal insertion holes 18 are sealed with the insulators 40 by bringing the closing plate 15 and the collector terminals 30 into intimate contact with the insulators 40 through the roughened portions 15b and 30a. The collector terminals 30 and the insulators 40 are immovably secured to the closing plate 15.

According to studies conducted by the inventor of the present application, when insert molding is performed such that the closing plate 15, the collector terminals 30, and the insulators are integral with each other, the area of contact between the closing plate 15 and the insulators is preferably increased to enhance the adhesion therebetween. Thus, the external connectors 34 and/or the second flanges 43 tend to be larger than those known in the art, so that the insulators (or specifically, the second flanges 43) and a fitted portion 14 tend to be close to each other on the outer surface 17 of the closing plate 15. Accordingly, the use of the techniques disclosed herein is particularly effective.

FIG. 4 is a plan view of the sealed battery 100 illustrated in FIG. 1. As illustrated in FIGS. 3 and 4, the fitted portion 14 is defined by a region where the closing plate 15 is fitted to the opening 12 of the battery case 11 (i.e., a juncture of the closing plate 15 and the battery case 11). The fitted portion 14 extends along an inner peripheral edge (or inner side walls) of the battery case 11 and an outer peripheral edge (or side walls) of the closing plate 15. The fitted portion 14 is located adjacent to the outer surface 17 of the closing plate 15. In the plan view, the fitted portion 14 is formed continuously along the boundary between the battery case 11 and the closing plate 15 such that the fitted portion 14 has a substantially rectangular shape. In the present embodiment, the collector terminals 30 and the insulators 40 are each disposed on an associated one of the ends of the closing plate 15 in the long-side direction Y. The fitted portion 14 is thus located close to the insulators 40 on the ends of the closing plate 15 in the long-side direction Y. In the present embodiment, the fitted portion 14 is located closest to the insulators in areas A on the ends of the closing plate 15 in the long-side direction Y.

The areas A are substantially equal in length to the insulators 40 in the long-side direction Y. The areas A may be longer or shorter in length than the insulators 40 by about 1 mm. Each of the areas A is an example of an “area where the fitted portion and the insulator are located closest to each other”. The distance between the fitted portion 14 and the insulator (or specifically, the second flange 43) in each of the areas A may be any suitable distance. The distance between the fitted portion 14 and the insulator 40 (or specifically, the second flange 43) in each of the areas A may be about 5 mm or less, may typically be 3 mm or less, or may be in the range of, for example, about 1 mm to 2 mm.

The fitted portion 14 is provided with a groove (or recess) 14N extending at least along peripheral edges of the external connectors 34 of the collector terminals 30. As illustrated in FIG. 3, the groove 14N is a recess defined in the upper surface of the battery case 11 and the outer surface 17 of the closing plate 15. As illustrated in FIG. 4, the groove 14N in the present embodiment is provided along the entire length of the fitted portion 14. The widths of the groove 14N in the short-side direction X and the long-side direction Y are each greater than the spot diameter of laser light to be used for laser welding. The groove 14N is preferably provided in each of the areas A where the fitted portion 14 and the insulator 40 are located closest to each other. For example, when the fitted portion 14 has a substantially rectangular shape as illustrated in FIG. 4, the groove 14N is preferably provided at least in long-side regions of the fitted portion 14 facing the insulators 40. This makes it possible to suitably achieve the effects of the techniques disclosed herein.

As illustrated in FIG. 3, a depth tn of the groove 14N (i.e., the length of the groove 14N in the up-down direction Z) is typically smaller than a thickness ta of the closing plate 15. The groove 14N may have any suitable depth tn. The depth tn of the groove 14N is preferably equal to or greater than ⅕ of the thickness ta of the closing plate 15, more preferably equal to or greater than ⅓ of the thickness ta, still more preferably equal to or greater than ½ of the thickness ta, and particularly preferably equal to or greater than ⅔ of the thickness ta. This makes it possible to achieve the effects of the techniques disclosed herein at higher level. In the present embodiment, the depth tn of the groove 14N is approximately ⅔ of the thickness ta of the closing plate 15. In the present embodiment, the groove 14N has a substantially rectangular shape when viewed in cross section. The groove 14N is provided by, for example, cutting at least one of the inner peripheral edge of the battery case 11 and the outer peripheral edge of the closing plate 15.

In the present embodiment, the groove 14N includes: a first groove N1 provided in the inner peripheral edge of the battery case 11; and a second groove N2 provided in the outer peripheral edge of the closing plate 15. In the present embodiment, the first groove N1 and the second groove N2 are each provided along the entire length of the fitted portion 14. In the present embodiment, the first groove N1 and the second groove N2 are similar in shape and symmetric with respect to a central line of the fitted portion 14. The first groove N1 and the second groove N2 each have a substantially rectangular shape in cross section. The side walls of the first groove N1 and the second groove N2 extend vertically or substantially vertically. When viewed in cross section, the battery case 11 and the closing plate 15 are connected to each other such that the lower ends of the first groove N1 and the second groove N2 are flush with each other. Alternatively, the first groove N1 and the second groove N2 may have different shapes. The lower ends of the first groove N1 and the second groove N2 may be located at different heights.

The exterior body 10 is airtightly sealed (or hermetically closed) by performing laser welding on the fitted portion 14 along its entire length. Performing laser welding on the fitted portion 14 fuses together a constituent metal of the battery case 11 and a constituent metal of the closing plate 15 such that a laser-welded region 14W is formed. The laser-welded region 14W is formed in the groove 14N of the fitted portion 14. An entirety of the laser-welded region 14W is preferably located within the groove 14N. In other words, the upper end of the laser-welded region 14W is preferably located below the upper surface of the battery case 11 and the upper surface (i.e., the outer surface 17) of the closing plate 15 when viewed in cross section. The sealed battery 100 in finished form is thus neat in appearance. Because the laser-welded region 14W does not protrude from the upper surfaces of the battery case 11 and the closing plate 15, the present embodiment is able to prevent damage to or breakage of the laser-welded region 14W caused by interference of the laser-welded region 14W with other member(s).

Method for Manufacturing Sealed Battery 100

The sealed battery 100 described above may be manufactured by, for example, a manufacturing method including a preparing step and a laser welding step.

The preparing step involves preparing the battery case 11 and the closing plate 15. The preparing step further involves preparing other necessary members mentioned above. In the present embodiment, the battery case 11 includes the first groove N1, and the closing plate 15 includes the second groove N2. The first groove N1 may be formed by, for example, cutting the inner peripheral edge of the battery case 11 into desired shape and size. Similarly, the second groove N2 may be formed by, for example, cutting the outer peripheral edge of the closing plate 15 into desired shape and size. In the present embodiment, an assembly component (e.g., the lid assembly 15A) is fabricated by making the collector terminals 30 and the insulators 40 integral with the closing plate 15 that has been prepared.

The lid assembly 15A may be fabricated by insert-molding the closing plate 15, the collector terminals 30, and the insulators 40. This makes it possible to not only reduce the number of components but also form conductive paths more easily than a conventional method that involves using rivets. Insert molding may be performed in accordance with any method known in the art, examples of which are described in JP 2021-086813 A, JP 2021-086814 A, Japanese Patent No. 3986368, and Japanese Patent No. 6648671. The lid assembly 15A may be fabricated by, for example, a method that involves using a molding die including a lower mold and an upper mold and includes a component setting step, a positioning step, an upper mold setting step, an injection molding step, an upper mold releasing step, and a component removing step.

The component setting step involves inserting the collector terminals 30 through the terminal insertion holes 18 of the closing plate 15, and then placing the closing plate 15 in the lower mold. The positioning step involves positioning the collector terminals 30 such that the collector terminals 30 are fixed. The upper mold setting step involves placing the upper mold such that the closing plate 15 and the collector terminals 30 are sandwiched between the upper and lower molds in the up-down direction. The injection molding step first involves heating the molding die. The injection molding step then involves injecting molten resin into the molding die. The molten resin flows from the upper mold to the lower mold through the terminal insertion holes 18. The injection molding step subsequently involves cooling the molding die and a resulting molded article. The insulators 40, the closing plate 15, and the collector terminals 30 are thus integral with each other. The upper mold releasing step involves separating the upper mold from the lower mold. The component removing step involves removing the molded article from the lower mold.

The laser welding step involves housing the electrode body 20 in the battery case 11 and then fitting the closing plate 15 to the opening 12 of the battery case 11. The closing plate 15 is thus assembled to the battery case 11 so as to form the groove 14N including the first groove N1 of the battery case 11 and the second groove N2 of the closing plate 15 facing each other. In the present embodiment, the groove 14N is formed along the entire length of the fitted portion 14. The groove 14N of the fitted portion 14 is then subjected to laser welding. In this case, the groove 14N serves as a guide indicating a location to be subjected to laser welding. This improves the workability of laser welding. Laser light to be used for laser welding may be similar to any type of laser light known in the art or any other suitable type of laser light. Laser welding may be performed under conditions similar to those known in the art or any other suitable conditions. The direction of laser application and the outer surface 17 (or horizontal surface) of the closing plate 15 typically form an angle of about 90°±10° (e.g., about 90°±5°). The fitted portion 14 including the groove 14N is subjected to laser welding along the entire length of the fitted portion 14, so that the closing plate 15 is welded to the battery case 11 without any gap therebetween.

FIG. 5 is a vertical cross-sectional view of a portion of the sealed battery 100 adjacent to the groove 14N during the laser welding step. As indicated by the thick arrow in FIG. 5, the present embodiment involves applying laser light IL to the groove 14N. The laser light IL applied to the groove 14N is reflected off, for example, the bottom surface of the groove 14N, which may produce reflected light as indicated by the thin arrows in FIG. 5. In the present embodiment, however, the reflected light produced is absorbed by side wall surfaces of the groove 14N. This makes it difficult for the reflected laser light to leak out of the groove 14N. Thus, if, for example, the fitted portion 14 is located close to the insulators 40 as in the areas A or the incident angle of the laser light IL is somewhat deviated, the techniques disclosed herein would make it unlikely that the reflected laser light will be applied to the insulators 40. Because the above-described effects are achieved, the present embodiment is able to prevent searing of the insulators 40 and eventually prevent a reduction in the insulating capacity of the insulators and a reduction in the airtightness of the sealed battery 100.

Purpose of Use of Sealed Battery 100

The sealed battery 100 is usable for various purposes. The sealed battery 100 is suitably usable as a motor power source (e.g., a driving power source) to be installed on, for example, a vehicle (such as a passenger car or a truck). The sealed battery 100 may be installed on any type of vehicle, examples of which include, but are not limited to, a plug-in hybrid electric vehicle (PHEV), a hybrid electric vehicle (HEV), and a battery electric vehicle (BEV).

Although the preferred embodiment of the sealed battery disclosed herein has been described thus far, the foregoing embodiment is only illustrative. The present application may be embodied in various other forms. The techniques disclosed herein may be carried out based on the disclosure of this specification and technical common knowledge in the related field. The techniques described in the claims include various changes and modifications made to the embodiment illustrated above.

In the example illustrated in FIG. 3, the groove 14N has a substantially rectangular cross-sectional shape and includes the first groove N1 and the second groove N2. The present application, however, is not limited to this example. Alternatively, the groove 14N may have any other suitable cross-sectional shape, such as a polygonal (e.g., a triangular) cross-sectional shape or a semicircular cross-sectional shape. The groove 14N may consist of the first groove N1 or the second groove N2. In other words, either one of the battery case 11 and the closing plate 15 may be provided with no groove.

First Variation

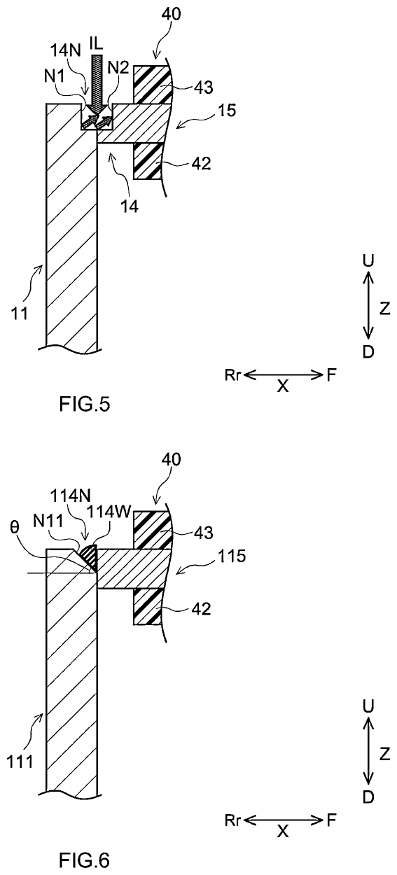

FIG. 6 is a vertical cross-sectional view of a portion of the sealed battery 100 according to a first variation, which is located adjacent to a groove 114N. The sealed battery 100 according to the first variation includes a battery case 111 similar to the battery case 11, except that the battery case 111 includes a first groove N11 instead of the first groove N1. The sealed battery 100 according to the first variation includes a closing plate 115 similar to the closing plate 15, except that the closing plate 115 includes no second groove N2. In the first variation, the groove 114N has a triangular shape in cross section. The groove 114N consists of the first groove N11. The first groove N11 includes a side wall inclined at an inclination angle θ. The inclination angle θ is, for example, between about 30° and about 60°. In the first variation, the inclination angle θ is about 45°. The sealed battery 100 according to the first variation includes a laser-welded region 114W that partially protrudes from the groove 114N and reaches an outer surface of the closing plate 115. Because the closing plate 115 is provided with no second groove N2, the first variation is able to make the sealed battery 100 compact while preventing damage to the insulators 40 and reduce the time and effort required to form the groove 114N.

Second Variation

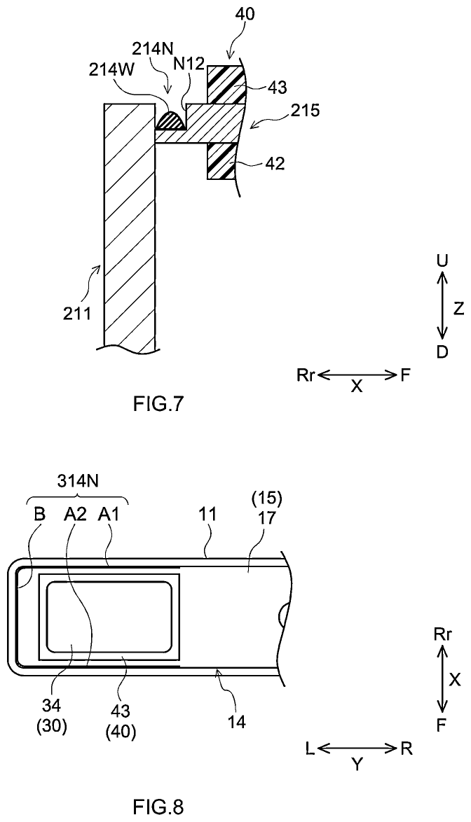

FIG. 7 is a vertical cross-sectional view of a portion of the sealed battery 100 according to a second variation, which is located adjacent to a groove 214N. The sealed battery 100 according to the second variation includes a battery case 211 similar to the battery case 11, except that the battery case 211 includes no first groove N1. The sealed battery 100 according to the second variation includes a closing plate 215 similar to the closing plate 15, except that the closing plate 215 includes a second groove N12 instead of the second groove N2. In the second variation, the groove 214N has a substantially rectangular shape in cross section. The groove 214N consists of the second groove N12. The sealed battery 100 according to the second variation includes a laser-welded region 214W entirely located within the groove 214N. Because the battery case 211 is provided with no first groove N1, the second variation is able to increase the strength of the battery case 211 while preventing damage to the insulators 40 and reduce the time and effort required to form the groove 214N.

Third Variation

In the example illustrated in FIG. 4, the groove 14N is provided along the entire length of the fitted portion 14. The present application, however, is not limited to this example. FIG. 8 is a plan view of a portion of the sealed battery 100 according to a third variation, which is located adjacent to a groove 314N. Although FIG. 8 illustrates the groove 314N located on the first side in the long-side direction Y (i.e., the left side), another similar groove 314N may be provided on the second side in the long-side direction Y (i.e., the right side). The following description is based on the assumption that the grooves 314N are each provided on an associated one of the first and second sides in the long-side direction Y. The grooves 314N each surround the associated insulator 40 from three directions. The grooves 314N are substantially U-shaped in the plan view. The grooves 314N each include: a first region A1 provided along a first long side of the closing plate 15; a second region A2 provided along a second long side of the closing plate 15; and a third region B which is provided along a short side of the closing plate 15 and through which the first and second regions A1 and A2 are connected to each other. Central regions of the fitted portion 14 in the long-side direction Y (i.e., regions of the fitted portion 14 in the long-side direction Y other than the first and second regions A1 and A2) are provided with no groove 314N. This variation is also able to suitably achieve the effects of the techniques disclosed herein.

As described above, specific embodiments of the techniques disclosed herein include those described in clauses below.

Clause 1: A sealed battery including: an electrode body including an electrode; a battery case including an opening and housing the electrode body; a closing plate including a terminal insertion hole and closing the opening; a fitted portion between the battery case and the closing plate; a collector terminal including an electrode body connector connected to the electrode inside the battery case, a shaft inserted through the terminal insertion hole, and an external connector exposed at an outer surface of the closing plate; and a resin insulator insulating the outer surface of the closing plate from the external connector, wherein at least in an area where the fitted portion and the insulator are located closest to each other, a groove is provided in the fitted portion, and the fitted portion including the groove is subjected to laser welding.

Clause 2: The sealed battery according to clause 1, wherein the closing plate, the collector terminal, and the insulator are insert-molded.

Clause 3: The sealed battery according to clause 1 or 2, wherein the fitted portion has a substantially rectangular shape, and the groove is provided at least in a long-side region of the fitted portion facing the insulator.

Clause 4: The sealed battery according to any one of clauses 1 to 3, wherein a laser-welded region formed by the laser-welding is located within the groove of the fitted portion.

Clause 5: The sealed battery according to any one of clauses 1 to 4, wherein the groove has a depth equal to or greater than ½ of a thickness of the closing plate.

Clause 6: The sealed battery according to any one of clauses 1 to 5, wherein the groove includes a first groove provided in the battery case.

Clause 7: The sealed battery according to any one of clauses 1 to 6, wherein the groove includes a second groove provided in the closing plate.

Clause 8: A method for manufacturing the sealed battery, the method including: a preparing step involving preparing the battery case and the closing plate, at least one of which includes a cut-out in the fitted portion; and a laser welding step involving housing the electrode body in the battery case, fitting the closing plate to the opening, and then performing laser welding on the fitted portion including the groove.

Clause 9: The method according to clause 8, wherein the preparing step includes fabricating an assembly component by insert-molding the collector terminal and the insulator to the closing plate that has been prepared.

Although the preferred embodiment of the present application has been described thus far, the foregoing embodiment is only illustrative, and the present application may be embodied in various other forms. The present application may be practiced based on the disclosure of this specification and technical common knowledge in the related field. The techniques described in the claims include various changes and modifications made to the embodiment illustrated above. Any or some of the technical features of the foregoing embodiment, for example, may be replaced with any or some of the technical features of variations of the foregoing embodiment. Any or some of the technical features of the variations may be added to the technical features of the foregoing embodiment. Unless described as being essential, the technical feature(s) may be optional.

### REFERENCE SIGNS LIST

10 exterior body
11 battery case
14 fitted portion
14N, 114N, 214N, 314N groove
N1, N11 first groove
N2, N12 second groove
14W, 114W, 214W laser-welded region
15 closing plate
15A lid assembly
18 terminal insertion hole
20 electrode body
30 collector terminal
34 external connector
40 insulator
43 second flange
100 sealed battery

What is claimed is:

1. A sealed battery comprising:
an electrode body including an electrode;
a battery case including an opening and housing the electrode body;
a closing plate including a terminal insertion hole and closing the opening;
a fitted portion between the battery case and the closing plate;
a collector terminal including
an electrode body connector connected to the electrode inside the battery case,
a shaft inserted through the terminal insertion hole, and
an external connector exposed at an outer surface of the closing plate; and
a resin insulator insulating the outer surface of the closing plate from the external connector, wherein
at least in an area where the fitted portion and the insulator are located closest to each other, a groove is provided in the fitted portion, and the fitted portion including the groove is subjected to laser welding.

2. The sealed battery according to claim 1, wherein
the closing plate, the collector terminal, and the insulator are insert-molded.

3. The sealed battery according to claim 1, wherein
the fitted portion has a substantially rectangular shape, and
the groove is provided at least in a long-side region of the fitted portion facing the insulator.

4. The sealed battery according to claim 1, wherein
a laser-welded region formed by the laser welding is located within the groove of the fitted portion.

5. The sealed battery according to clause 1, wherein
the groove has a depth equal to or greater than ½ of a thickness of the closing plate.

6. The sealed battery according to claim 1, wherein
the groove includes a first groove provided in the battery case.

7. The sealed battery according to claim 1, wherein
the groove includes a second groove provided in the closing plate.

8. A method for manufacturing a sealed battery including:
an electrode body including an electrode;
a battery case including an opening and housing the electrode body;
a closing plate including a terminal insertion hole and closing the opening;
a fitted portion between the battery case and the closing plate;
a collector terminal including
an electrode body connector connected to the electrode inside the battery case,
a shaft inserted through the terminal insertion hole, and
an external connector exposed at an outer surface of the closing plate; and
a resin insulator insulating the outer surface of the closing plate from the external connector, wherein
at least in an area where the fitted portion and the insulator are located closest to each other, a groove is provided in the fitted portion, and the fitted portion including the groove is subjected to laser welding, and
the method comprises:
a preparing step involving preparing the battery case and the closing plate, at least one of which includes a cut-out in the fitted portion; and
a laser welding step involving housing the electrode body in the battery case, fitting the closing plate to the opening, and then performing laser welding on the fitted portion including the groove.

9. The method according to claim 8, wherein
the preparing step includes fabricating an assembly component by insert-molding the collector terminal and the insulator to the closing plate that has been prepared.
